(19) United States
(12) Patent Application Publication
(10) Pub. No.: US 2016/0092632 A1
(43) Pub. Date: Mar. 31, 2016

(54) Cloud-Based Processing of Medical Imaging Data

(71) Applicant: Siemens Product Lifecycle Management Software Inc., Plano, TX (US)

(72) Inventors: Shaohua Kevin Zhou, Plainsboro, NJ (US); Neil Birkbeck, Santa Cruz, CA (US); Giorgio Di Guardia, Plainsboro, NJ (US); Jingdan Zhang, Bellevue, WA (US); Michal Sofka, Franklin Park, NJ (US); James B. Thompson, St. Charles, IL (US); Gianluca Paladini, Skillman, NJ (US)

(21) Appl. No.: 14/496,042

(22) Filed: Sep. 25, 2014

(51) Int. Cl. G06F 19/00

(52) U.S. Cl. CPC G06F 19/321

(57) ABSTRACT

A method for processing medical imaging data includes: (a) selecting a subset of medical imaging data to be processed, wherein the medical imaging data is stored in a cloud-based storage system; (b) choosing a processing algorithm to apply to the selected subset of medical imaging data, wherein the chosen processing algorithm is stored in the cloud-based storage system; (c) executing the chosen processing algorithm in the cloud-based storage system to generate a processing result; and (d) displaying the processing result to a client via a user interface. Systems for processing medical imaging data are described.

### TECHNICAL FIELD

The present teachings relate generally to cloud-based platforms for the processing of medical imaging data and, in some embodiments, to cloud-based platforms for use within client-server architectures.

### BACKGROUND

Medical imaging data acquired from a patient—for example, computed tomography (CT) data, magnetic resonance imaging (MRI) data, and/or the like—may be stored in a remote data center and, subsequently, downloaded to a local computer for processing by a user (e.g., a physician, a technician, an algorithm developer, and/or the like). The processing of medical imaging data on a local computer may include image analysis, segmentation of anatomical structures, annotation of data, management of metadata, and/or the like. Sometimes, the results of such image processing may then be used in pre-operative surgical planning. For example, the results of an anatomical segmentation of a patient's knee may be used in planning a personalized strategy for a surgical replacement of the knee with an implant.

The process of uploading medical imaging data to a remote data center (e.g., a private cloud) and then downloading all or a portion of that medical imaging data to one or more local computers for the image analysis (e.g., segmentation) is inefficient. The inefficiency is exacerbated by the fact that image analysis sites that perform one or more aspects of image analysis may be globally distributed.

### SUMMARY

The scope of the present invention is defined solely by the appended claims, and is not affected to any degree by the statements within this summary.

Cloud-based solutions for medical image analytics, data management, reporting, and/or algorithm development have been discovered and are described herein. In accordance with the present teachings, medical imaging data and various processing algorithms for processing medical imaging data may be stored in a cloud-based server. A client may browse these available data (e.g., using a web-based browser), select a subset of the data for which processing is desired (e.g., data associated with a specific patient), decide what type of processing to perform with respect to the subset of data (e.g., segmentation of an anatomical structure), and choose a corresponding processing algorithm to achieve the desired processing. The processing may then be performed in the cloud and, upon completion, a processing result may be transmitted back to the client (e.g., via a web-based browser). In some embodiments, cloud-based platforms in accordance with the present teachings may incorporate a modular design, whereby one or more network segments of the medical image processing may be parallelized, thereby substantially improving computational efficiency.

By way of introduction, a computer-implemented method for processing medical imaging data in accordance with the present teachings includes: (a) selecting, by a first computer processor, a subset of medical imaging data to be processed, wherein the medical imaging data is stored in a cloud-based storage system; (b) choosing, by the first computer processor, a processing algorithm to apply to the selected subset of medical imaging data, wherein the chosen processing algorithm is stored in the cloud-based storage system; (c) executing, by a second computer processor, the chosen processing algorithm in the cloud-based storage system to generate a processing result; and (d) displaying the processing result to a client via a user interface.

A system for processing medical imaging data in accordance with the present teachings includes: (a) a first computer processor; (b) a first non-transitory memory coupled with the first computer processor; (c) first logic stored in the first non-transitory memory and executable by the first computer processor to cause the first computer processor to select a subset of medical imaging data to be processed, wherein the medical imaging data is stored in a cloud-based storage system; (d) second logic stored in the first non-transitory memory and executable by the first computer processor to cause the first computer processor to choose a processing algorithm to be applied to the selected subset of medical imaging data, wherein the chosen processing algorithm is stored in the cloud-based storage system; (e) a second computer processor in communication with the first computer processor over a network; (f) a second non-transitory memory coupled with the second computer processor; (g) third logic stored in the second non-transitory memory and executable by the second computer processor to cause the second computer processor to execute the chosen processing algorithm in the cloud-based storage system to generate a processing result; and (h) fourth logic stored in the second non-transitory memory and executable by the second computer processor to cause the second computer processor to display the processing result to a client via a user interface.

A non-transitory computer readable storage medium in accordance with the present teachings has stored therein data representing instructions executable by a programmed processor for processing medical imaging data. The storage medium includes instructions for: (a) selecting a subset of medical imaging data to be processed, wherein the medical imaging data is stored in a cloud-based storage system; (b) choosing a processing algorithm to apply to the selected subset of medical imaging data, wherein the chosen processing algorithm is stored in the cloud-based storage system; (c) executing the chosen processing algorithm in the cloud-based storage system to generate a processing result; and (d) displaying the processing result to a client via a user interface.

### BRIEF DESCRIPTION OF THE DRAWINGS

FIG. 1 shows a flow chart of a representative method for processing medical imaging data in accordance with the present teachings.

FIG. 2 shows a block diagram of an exemplary client-server architecture in accordance with the present teachings.

FIG. 3 shows an example of a multi-tiered application programming interface (API) stack in accordance with the present teachings.

FIG. 4 shows a block diagram of an example of a processing algorithm configured for parallelization.

FIG. 5 shows a block diagram of three exemplary network segments that are configured to run in parallel after a first exemplary network segment is complete.

FIG. 6 shows a block diagram of an example of two network segments that include send/receive modules.

FIG. 7 shows an example of a web-based browser configured for selecting data to be processed and for choosing an algorithm to use in the processing.

FIG. 8 shows a block diagram of a representative system for processing medical imaging data in accordance with the present teachings.

FIG. 9 shows a representative general computer system for use with a system in accordance with the present teachings.

FIG. 10 shows a schematic illustration of exemplary hardware that may be used in accordance with the present teachings.

FIG. 11 shows an example of exemplary software that may be used in accordance with the present teachings.

### DETAILED DESCRIPTION

Cloud-based solutions for medical image analytics, data management, reporting, and/or algorithm development have been discovered and are described herein. In some embodiments, web-based system architectures facilitate management of medical image data, annotation, and meta-data. System architectures in accordance with the present teachings may be configured to run analytic algorithms on the medical image data and to support the reporting and analysis of algorithm performance, patient history, segmentation, annotation history, and/or the like.

In accordance with the present teachings, a flexible, scalable design is provided that allows horizontal scaling of data storage. Scalability of data storage may be used to accommodate constant growth of data. Moreover, centralizing the storage of data (e.g., in a cloud-based storage system) may be used to facilitate patient access and queries. In addition to providing data storage scalability, the flexible, scalable design of a cloud-based platform in accordance with the present teachings may also provide computation scalability and allow computation to span multiple nodes (e.g., for batch- and single-detection). Moreover, the flexible, scalable design may further facilitate uploading and integration of new analytic components and may expedite benchmarking and prototyping (e.g., thereby fostering scientific development).

In some embodiments, an application programming interface (API) is provided whereby multiple applications and workflows (e.g., rendering, analytics for algorithms, database searching, etc.) may be built upon a single platform. The API may be used for searching and accessing patient data and algorithm results. Moreover, the API may be configured to allow a user to schedule automatic algorithm processing in connection with one or a plurality of patient cases. Full-featured client applications and workflows (e.g., with visualization and rendering) may be written in a multitude of environments, including but not limited to native web-based, native application, mobile applications, and/or the like.

It is to be understood that elements and features of the various representative embodiments described below may be combined in different ways to produce new embodiments that likewise fall within the scope of the present teachings.

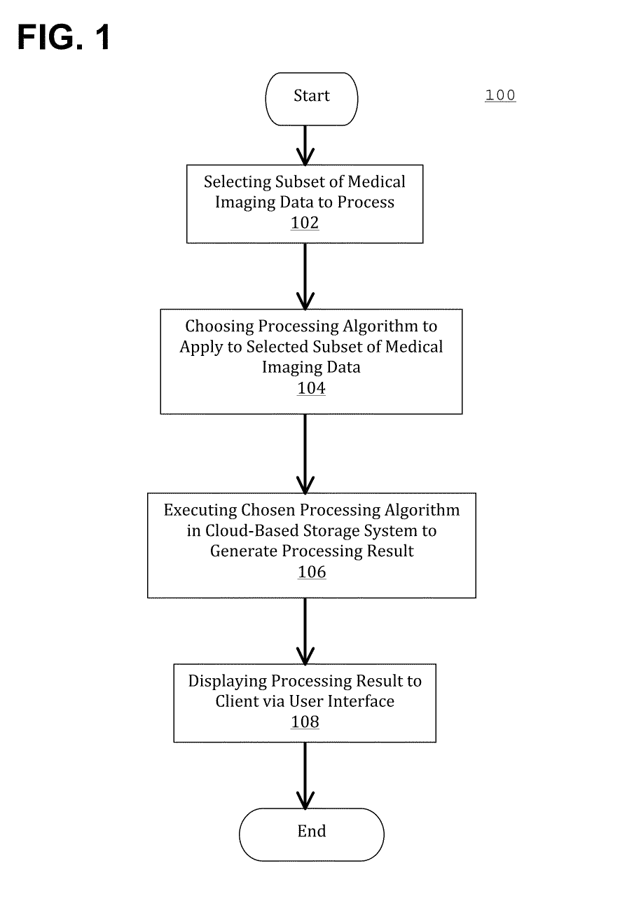

FIG. 1 shows a representative method 100 in accordance with the present teachings for processing medical imaging data. As shown in FIG. 1, the method 100 includes: (a) selecting 102 a subset of medical imaging data to be processed, wherein the medical imaging data is stored in a cloud-based storage system; (b) choosing 104 a processing algorithm to apply to the selected subset of medical imaging data, wherein the chosen processing algorithm is stored in the cloud-based storage system; (c) executing 106 the chosen processing algorithm in the cloud-based storage system to generate a processing result; and (d) displaying 108 the processing result to a client via a user interface.

All manner of medical imaging data are contemplated for use in accordance with the present teachings. Representative types of medical imaging data include but are not limited to computed tomography (CT) data, magnetic resonance imaging (MRI) data, ultrasound data, fluoroscopy data, x-ray data, positron emission data, and/or the like, and combinations thereof. In some embodiments, the subset of medical imaging data selected in accordance with the present teachings includes data that correspond to a specific patient or to a selected plurality of specific patients (e.g., patients grouped by one or more common characteristics, such as disease type, medical history, age, gender, and/or the like). In some embodiments, the subset of medical imaging data includes CT data, MRI data, or a combination thereof.

All manner of processing of medical imaging data is contemplated for use in accordance with the present teachings. Representative types of processing include but are not limited to analyzing, detecting, segmenting (e.g., an anatomical structure), rendering (e.g., volume rendering, surface rendering, etc.), modeling, annotating, comparing, reporting, and/or the like, and combinations thereof.

In some embodiments, a method for processing medical imaging data in accordance with the present teachings is implemented using a computer and, in some embodiments, one or a plurality of the acts of selecting 102, choosing 104, executing 106, and/or displaying 108 shown in FIG. 1 may be performed by one or a plurality of processors. The processors are able to render more quickly and consistently than a person. In a time-constrained medical environment, processor-based image generation assists diagnosis and/or treatment in ways that a human-created image could not.

The relative ordering of some acts shown in the flow chart of FIG. 1 is meant to be merely representative rather than limiting, and alternative sequences may be followed. Moreover, additional, different, or fewer acts may be provided, and two or more of these acts may occur sequentially, substantially contemporaneously, and/or in alternative orders. By way of a non-limiting and representative example, in FIG. 1, the act of choosing 104 is shown as following the act of selecting 102. However, in alternative embodiments, the sequence of these acts may be reversed.

In some embodiments, methods in accordance with the present teachings may further include transmitting information (e.g., medical imaging data acquired from a patient, physician-provided annotations to patient data, patient-identification information, and/or the like) to the cloud-based storage system over a network and/or storing the transmitted information in the cloud-based storage system. In some embodiments, as further described below, the executing 106 of the chosen processing algorithm in the cloud-based storage system to generate a processing result may include parallel processing of at least two modules of the chosen processing algorithm.

In some embodiments, the cloud-based storage system includes a plurality of processing algorithms. In some embodiments, each processing algorithm of the plurality of processing algorithms is configured to run in the cloud-based storage system. In some embodiments, a cloud-based storage system in accordance with the present teachings includes one or a plurality of remote servers. In some embodiments, the cloud is configured for transmitting data to and/or receiving data from one or a plurality of local computers that may be located in one or a plurality of remote locations. In some embodiments, the transmitting and/or receiving may be achieved wirelessly.

In some embodiments, the user-interface may include a web-based browser of a type, for example, that is accessible via a local computer station (e.g., desktop computer, laptop computer, notepad, or the like), mobile device (e.g., cell phone), and/or the like.

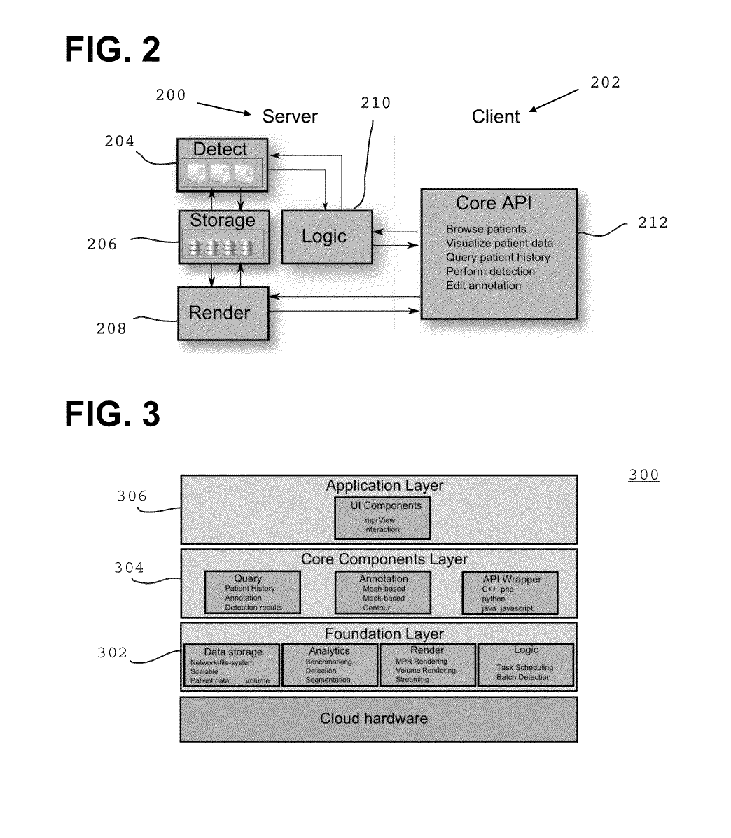

FIG. 2 shows a block diagram of a representative client-server architecture that may be used in accordance with the present teachings. As shown in FIG. 2, the server 200 may include a storage module 206 (e.g., to provide scalable data), a logic module 210 (e.g., a fault tolerant logic controller), an analytics/detection module 204 (e.g., to provide scalable elastic computation), and/or a render module 208 (e.g., to provide elastic render nodes for client applications). The client 202 (e.g., a local computer in communication with server 200 over a network) may include a core API 212 with which a client may browse patient data, select data for visualization, select data for processing, and/or the like.

FIG. 3 shows an example of a representative multi-tiered API stack 300 that may be provided in accordance with the present teachings. As shown in FIG. 3, the exemplary API stack 300 may include a foundation layer 302 (e.g., that contains the modules 204, 206, 208, and 210 shown in FIG. 2), a core components layer 304 (e.g., that contains modules for query, annotation access, and helper API wrappers), and an application layer 306 (e.g., that contains user interface components). The foundation layer 302 may provide a low-level API and interconnect between server nodes. The application layer 306 may provide high-level utilities for building workflows.

Cloud-based platforms in accordance with the present teachings may include a network (e.g., for executing a processing algorithm in the cloud) and, in some embodiments, methods in accordance with the present teachings may further include partitioning the network into a plurality of network segments. Each network segment of the plurality of network segments may include one or a plurality of modules associated with the processing algorithm. Many image detection, segmentation, and algorithm tasks may be represented using a simple abstraction model (e.g., data 1>module 1>data 2). In such configurations, algorithm designers may write self-contained modules that may be connected to other modules, thereby creating larger connected algorithm graphs. Moreover, as further described below, the partitioning of the network into a plurality of segments (each of which may contain one or a plurality of modules that implements at least a portion of a processing algorithm), allows for parallelization.

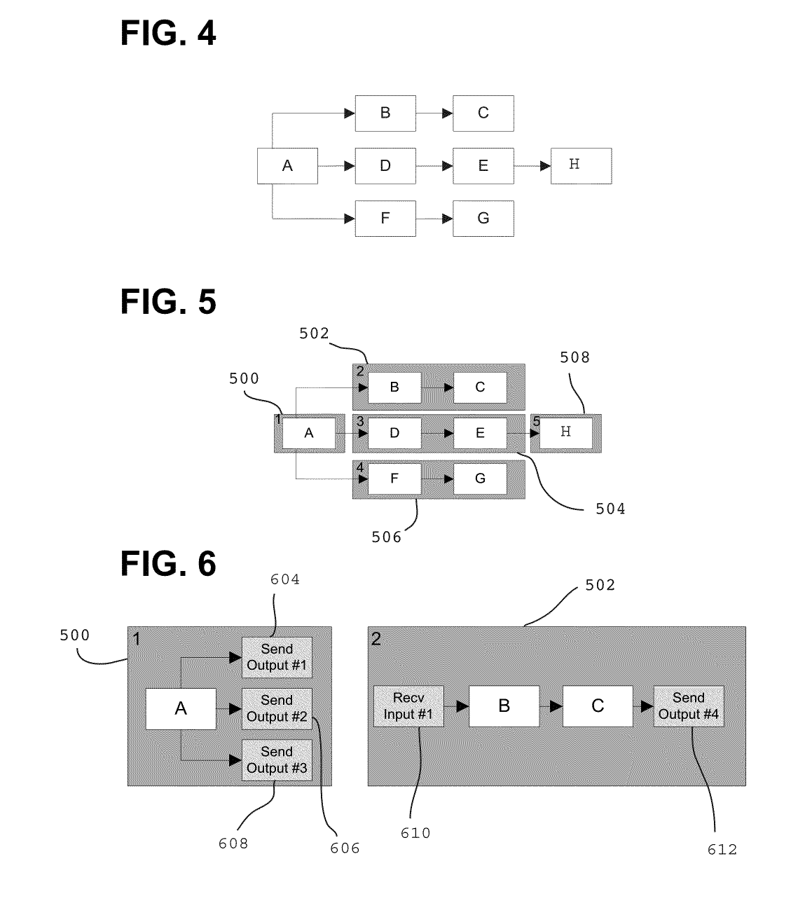

FIG. 4 shows a block diagram of an example of a processing algorithm configured for parallelization. The processing algorithm includes a plurality of modules A, B, C, D, E, F, G, and H. As shown in FIG. 4, the output from module A is input into module B, module D, and module F. The output of module B is input into module C. The output of module D is input into module E and the output of module E is input into module H. Similarly, the output of module F is input into module G. As structured in FIG. 4, the processing algorithm is configured to be partitioned into different network segments that may be run on different machines.

By way of example, FIG. 5 shows a block diagram of an example of a second network segment 502, a third network segment 504, and a fourth network segment 506, each of which is configured for data transfer with other network segments. A shown in FIG. 5, the second network segment 502, the third network segment 504, and the fourth network segment 506 may run in parallel in the cloud after a first network segment 500 is complete. A fifth network segment 508 is configured to run after completion of the third network segment 504. As shown in FIG. 5, the second network segment 502 contains modules B and C, the third network segment 504 contains modules D and E, the fourth network segment 506 contains modules F and G, the first network segment 500 contains module A, and the fifth network segment 508 contains module F.

In some embodiments, each network segment of a plurality of network segments is independently configured to run on a separate machine. For example, as shown in FIG. 5, each of first network segment 500, second network segment 502, third network segment 504, fourth network segment 506, and fifth network segment 508 is configured to run on a separate computer (e.g., computers 1, 2, 3, 4, and 5, respectively).

In accordance with the present teachings, as shown in FIG. 5, two or more of a plurality of network segments may be configured to run in parallel in a cloud-based storage system (e.g., second network segment 502, third network segment 504, fourth network segment 506). Moreover, the partitioning into a plurality of network segments may be performed—manually or automatically—in order to optimize the overall computation (e.g., processing result).

In some embodiments, each network segment of a plurality of network segments may be controlled by a common driver. The abstraction of data allows a single driver program to traverse a graphical representation of the detection network. Thus, algorithms may be specified by their detection model/network and the names of the modules that should be run. This modularity allows new algorithms to be plugged in with a single driver program. In addition, batch algorithms may be run on multiple machines. Single algorithms may be parallelized automatically by analyzing the structure of a detection network (e.g., any algorithm may be run in parallel on multiple machines using the same driver program).

In some embodiments, network segments may be altered to automatically transmit and/or receive data. Requested outputs from each network segment may be identified and “Send/Recv” modules may be augmented into the subnetwork. These network segments may be run with the same driver program, with parallelization communication embedded in the network. For example, two or more (and, in some embodiments, each) of the plurality of network segments may be configured for transferring data to and/or receiving data from a different network segment. By way of example, FIG. 6 shows a block diagram of the first network segment 500 and the second network segment 502 that include send/receive modules. As shown in FIG. 6, module A is connected to each of a first send module 604, a second send module 606 and a third send module 608. The second network segment 502 is connected to a first receive module 610 at one end and a fourth output module 612 at the other.

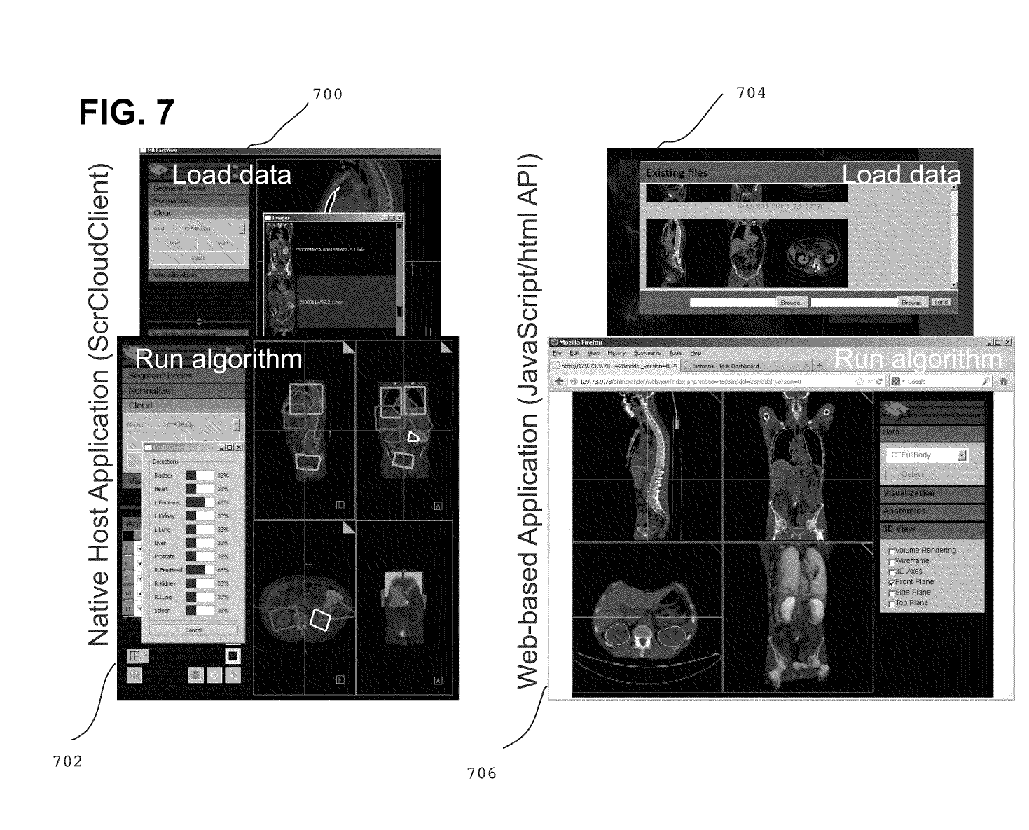

FIG. 7 shows a representative example of a core components layer (e.g., layer 304 of FIG. 3) and an application layer (e.g., layer 306 of FIG. 3) in accordance with the present teachings. As shown in FIG. 7, a user interface 700 (e.g., a web-based browser) may be configured for selecting data to be processed (e.g., “Load data”), and a screen 702 may be configured for choosing an algorithm to use in the processing (e.g., “Run algorithm”). The screen 702 shows an example wherein bounding boxes may be defined for use in segmenting various organs. As further shown in FIG. 7, a web-based browser 704 may be configured for displaying the subset of medical imaging data selected on screen 700, and the screen 706 may be configured for displaying the processing algorithm chosen on screen 702 for application to the selected subset of medical imaging data.

In some embodiments, methods for processing medical imaging data in accordance with the present teachings may be used in planning a surgery (e.g., orthopedic surgery, cardiac surgery, neurosurgery, etc.). In some embodiments, the methods may be used in orthopedic surgical procedures including but not limited to knee replacements and/or hip replacements.

At present, patient image data may be stored in private cloud data centers. The image data may then be downloaded to a local computer for image analysis in order to segment out anatomical structures (e.g., a knee joint to be replaced). This process is ineffective since analysis sites are oftentimes distributed globally. In contrast to the inefficient desktop-based segmentation presently used, methods in accordance with the present teachings allow image processing to be performed on a cloud-based platform, and the processing results to be delivered to clients on demand. In some embodiments, the processing algorithm executed in the cloud-based storage system in accordance with the present teachings is configured to generate patient-specific information for use in surgery planning, orthopedic implant design, surgical instrument design, surgical instrument placement, and/or the like, and combinations thereof.

In some embodiments, as described above, the present teachings provide methods for processing medical imaging data. In other embodiments, as further described below, the present teachings also provide systems for processing medical imaging data.

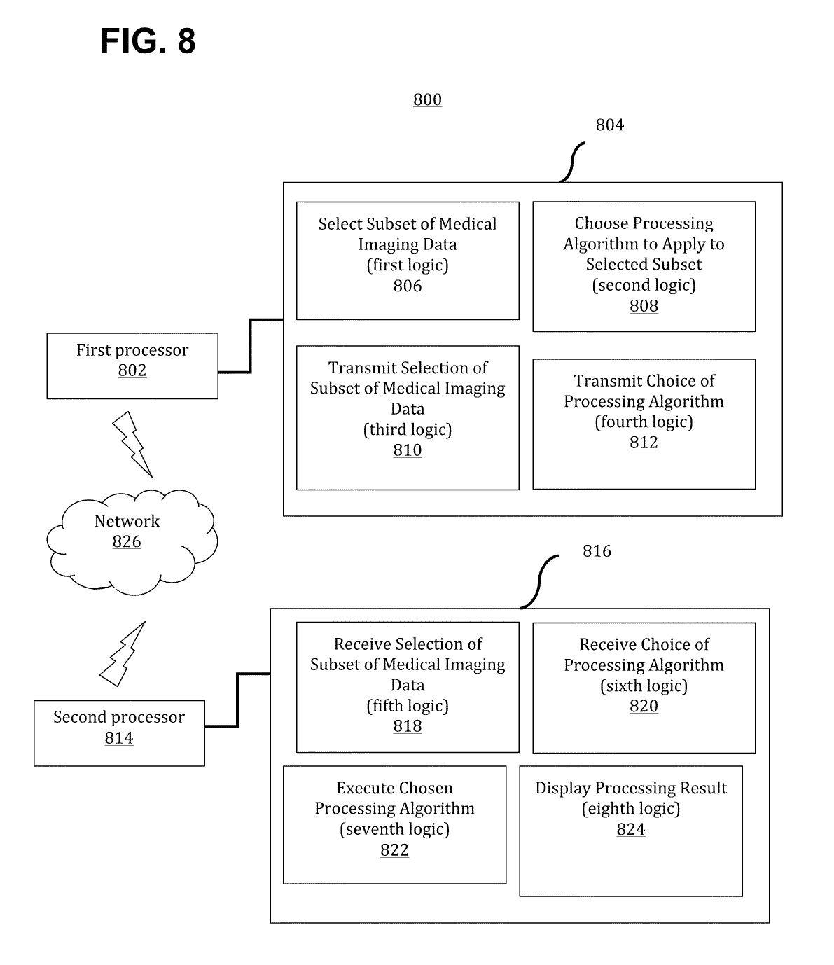

By way of example, a system for processing medical imaging data in accordance with the present teachings may be implemented as part of a medical imaging analytics module in a computer system. FIG. 8 shows a block diagram of a representative system 800 for processing medical imaging data in accordance with the present teachings. As shown in FIG. 8, the system 800 includes: a first processor 802; a first non-transitory memory 804 coupled with the first processor 802; first logic 806 stored in the first non-transitory memory 804 and executable by the first processor 802 to cause the first processor 802 to select a subset of medical imaging data to be processed, wherein the medical imaging data is stored in a cloud-based storage system; second logic 808 stored in the first non-transitory memory 804 and executable by the first processor 802 to cause the first processor 802 to choose a processing algorithm to be applied to the selected subset of medical imaging data, wherein the chosen processing algorithm is stored in the cloud-based storage system; third logic 810 stored in the first non-transitory memory 804 and executable by the first processor 802 to cause the first processor 802 to transmit (e.g. to the cloud-based storage system) the selection of the subset of medical imaging data to be processed; and fourth logic 812 stored in the first non-transitory memory 804 and executable by the first processor 802 to cause the first processor 802 to transmit (e.g., to the cloud-based storage system) the choice of processing algorithm to be applied to the selected subset of medical imaging data.

In some embodiments, as shown in FIG. 8, the system 800 further includes a second computer processor 814 in communication with the first computer processor 802 over a network 826; a second non-transitory memory 816 coupled with the second computer processor 814; fifth logic 818 stored in the second non-transitory memory 816 and executable by the second processor 814 to cause the second computer processor 814 to receive the selection of the subset of medical imaging data to be processed; sixth logic 820 stored in the second non-transitory memory 816 and executable by the second computer processor 814 to cause the second computer processor 814 to receive the choice of processing algorithm to be applied to the selected subset of medical imaging data; seventh logic 822 stored in the second non-transitory memory 816 and executable by the second processor 814 to cause the second computer processor 814 to execute the chosen processing algorithm in the cloud-based storage system to generate a processing result; and eighth logic 824 stored in the second non-transitory memory 816 and executable by the second processor 814 to cause the second computer processor 814 to display the processing result to a client via a user interface.

In some embodiments, the system 800 may be coupled to other modules of a computer system and/or to databases so as to have access to relevant information as needed (e.g., patient medical history, physician and/or hospital identifying information, etc.) and initiate appropriate actions.

A non-transitory computer-readable storage medium in accordance with the present teachings has stored therein data representing instructions executable by a programmed processor for processing medical imaging data. The storage medium includes instructions for: (a) selecting a subset of medical imaging data to be processed, wherein the medical imaging data is stored in a cloud-based storage system; (b) choosing a processing algorithm to apply to the selected subset of medical imaging data, wherein the chosen processing algorithm is stored in the cloud-based storage system; (c) executing the chosen processing algorithm in the cloud-based storage system to generate a processing result; and (d) displaying the processing result to a client via a user interface.

One or more modules or logic described herein may be implemented using, among other things, a tangible computer-readable medium comprising computer-executable instructions (e.g., executable software code). Alternatively, modules may be implemented as software code, firmware code, hardware, and/or a combination of the aforementioned. For example the modules may be embodied as part of an image analysis system.

The following examples and representative procedures illustrate features in accordance with the present teachings, and are provided solely by way of illustration. They are not intended to limit the scope of the appended claims or their equivalents.

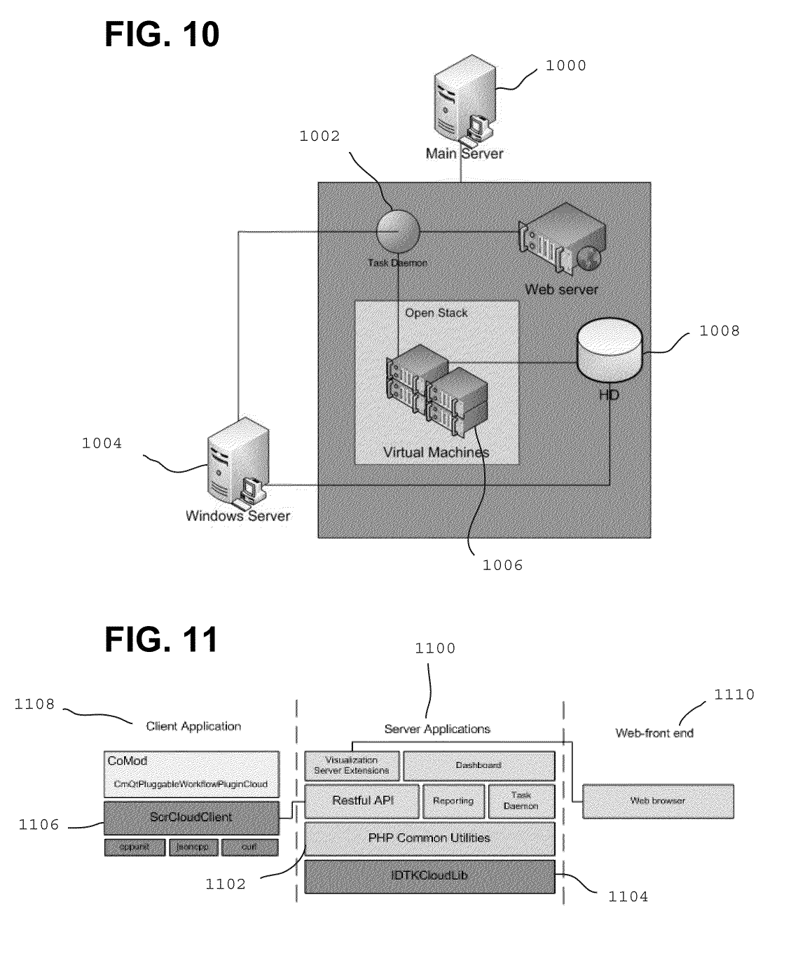

FIG. 10 shows a representative configuration of exemplary hardware that may be used to implement a system in accordance with the present teachings. By way of example, the system may include a logic controller that, in some embodiments, may be provided as a main server 1000 (e.g., apache, mysql, php) and may host an API. In some embodiments, computational nodes may be coordinated by a separate server, such as a Task Daemon 1002. One or a plurality of external WINDOWS-based machines 1004 (e.g., ideally fast interconnect) may be used as the computational nodes. In some embodiments, a plurality of virtual machines 1006 may be included. Storage may be provided by a hard disk 1008 and replaceable with a scalable file system.

FIG. 11 shows a representative configuration of exemplary software that may be used in a system in accordance with the present teachings. By way of example, a server stack 1100 may include PHP Common Utilities 1102 (e.g., core components layer) and IDTK Cloud Lib 1104 (e.g., foundation layer). An external applications (native or web-based) interface with server using REST-based protocol may also be used. As shown in FIG. 11, ScrCloudClient 1106 (e.g., core components layer c++/curl interface to cloud) may be used in client application layer 1108. The web front end 1110 may include a web-based interface (e.g., core components/application layer). In some embodiments, task daemons may be used for managing analytics jobs.

As described above, the computational efficiency of medical image processing may be improved using cloud-based platforms in accordance with the present teachings. For example, as described above, one or more network segments may be parallelized, thereby providing improvements in computational efficiency. Two representative examples of improved computational efficiency that may be achieved through parallelization will now be described.

In a first example, four bones in an image of a knee joint (e.g., the femur, tibia, fibula, and patella) are detected via segmentation. A representative system for use in this experiment is summarized in Table 1.

TABLE 1
System Specifications

| | |
|---|---|
| Processor: | INTEL XEON CPU GHz X560 @ 2.67 GHz 2.66 |
| | (2 processors) |
| Installed memory | 72.0 GB |
| (RAM): | |
| System type: | 64-bit Operating System |
| Pen and Touch: | No Pen or Touch Input is available for this Display |

When a single process is used for the segmentation of the knee joint (e.g., using fine-scale multithreaded of modules), the computation takes about 79 seconds. When four processes are used for the segmentation (e.g., openmpi implementation), the time is reduced to about 31 seconds. Thus, an improvement in speed by a factor of about 2.5 is achieved by running the processes on the same hardware with four processes.

In a second example, 11 organs (e.g., left and right kidneys, left and right lung, spleen, heart, liver, bladder, prostate, left and right femur, and head) are detected via segmentation. In this experiment, two machines (mpich implementation) are used: one 64 core (cloudmachine) and one 8 core (pccs000168ws). There is a maximum of 12 threads per job. The different times achievable based on the different machine configurations are summarized in Table 2. As a point of comparison, the computations for segmenting the 11 organs would take about 2 minutes to complete using a single process run on a single machine—a substantially longer time than the times shown in Table 2.

TABLE 2
Performance Improvements Using Multiple Processes

| | TIME |
|---|---|
| MACHINE CONFIGURATION | (Seconds) |
| Baseline: Detectionsystem2 | 16.7 |
| Cloudmachine (1 process, 64 threads) | |
| Cloudmachine (10 processes) + | 5.77 |
| pccs000168ws (2 processes) | |
| Cloudmachine (12 processes) | 6.47 |

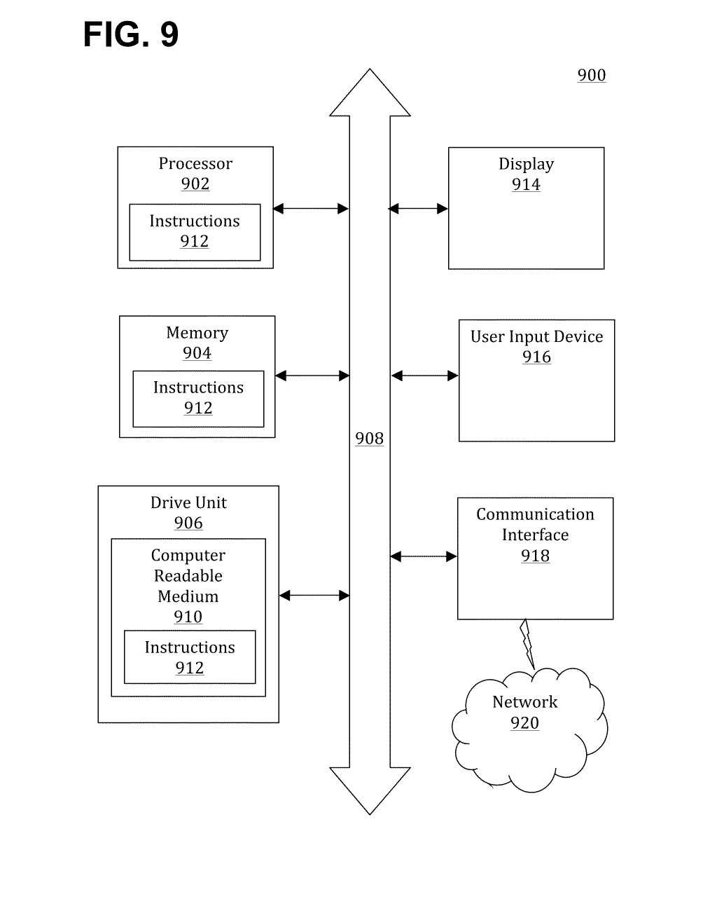

FIG. 9 depicts an illustrative embodiment of a general computer system 900. The computer system 900 can include a set of instructions that can be executed to cause the computer system 900 to perform any one or more of the methods or computer based functions disclosed herein. The computer system 900 may operate as a standalone device or may be connected (e.g., using a network) to other computer systems or peripheral devices. Any of the components discussed above, such as the processor, may be a computer system 900 or a component in the computer system 900. The computer system 900 may implement a medical image processing system, of which the disclosed embodiments are a component thereof.

In a networked deployment, the computer system 900 may operate in the capacity of a server or as a client user computer in a client-server user network environment, or as a peer computer system in a peer-to-peer (or distributed) network environment. The computer system 900 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In some embodiments, the computer system 900 may be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As shown in FIG. 9, the computer system 900 may include a processor 902, for example a central processing unit (CPU), a graphics-processing unit (GPU), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904 that may communicate via a bus 908. The memory 904 may be a main memory, a static memory, or a dynamic memory. The memory 904 may include, but is not limited to, computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In some embodiments, the memory 904 includes a cache or random access memory for the processor 902. In alternative embodiments, the memory 904 is separate from the processor 902, such as a cache memory of a processor, the system memory, or other memory. The memory 904 may be an external storage device or database for storing data. Examples include a hard drive, compact disc (CD), digital video disc (DVD), memory card, memory stick, floppy disc, universal serial bus (USB) memory device, or any other device operative to store data. The memory 904 is operable to store instructions executable by the processor 902. The functions, acts or tasks illustrated in the figures or described herein may be performed by the programmed processor 902 executing the instructions 912 stored in the memory 904. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown in FIG. 9, the computer system 900 may further include a display unit 914, such as a liquid crystal display (LCD), an organic light emitting diode (OLED), a flat panel display, a solid state display, a cathode ray tube (CRT), a projector, a printer or other now known or later developed display device for outputting determined information. The display 914 may act as an interface for the user to see the functioning of the processor 902, or specifically as an interface with the software stored in the memory 904 or in the drive unit 906. A value or image based on the image processing may be output to the user on the display unit 914. For example, an image representing part of the patient with modulation or alphanumeric text representing a calculated value may be indicated in the image.

Additionally, as shown in FIG. 9, the computer system 900 may include an input device 916 configured to allow a user to interact with any of the components of system 900. The input device 916 may be a number pad, a keyboard, or a cursor control device, such as a mouse, or a joystick, touch screen display, remote control or any other device operative to interact with the system 900.

In some embodiments, as shown in FIG. 9, the computer system 900 may also include a disk or optical drive unit 906. The disk drive unit 906 may include a computer-readable medium 910 in which one or more sets of instructions 912 (e.g., software) may be embedded. Further, the instructions 912 may embody one or more of the methods or logic as described herein. In some embodiments, the instructions 912 may reside completely, or at least partially, within the memory 904 and/or within the processor 902 during execution by the computer system 900. The memory 904 and the processor 902 also may include computer-readable media as described above.

The present teachings contemplate a computer-readable medium that includes instructions 912 or receives and executes instructions 912 responsive to a propagated signal, so that a device connected to a network 920 may communicate voice, video, audio, images or any other data over the network 920. Further, the instructions 912 may be transmitted or received over the network 920 via a communication interface 918. The communication interface 918 may be a part of the processor 902 or may be a separate component. The communication interface 918 may be created in software or may be a physical connection in hardware. The communication interface 918 is configured to connect with a network 920, external media, the display 914, or any other components in system 900, or combinations thereof. The connection with the network 920 may be a physical connection, such as a wired Ethernet connection or may be established wirelessly as discussed below. Likewise, the additional connections with other components of the system 900 may be physical connections or may be established wirelessly.

The network 920 may include wired networks, wireless networks, or combinations thereof. The wireless network may be a cellular telephone network, an 802.11, 802.16, 802.20, or WiMax network. Further, the network 920 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification may be implemented in digital electronic circuitry, or in computer software, firmware, or hardware, including the structures disclosed in this specification and their structural equivalents, or in combinations of one or more of them. Embodiments of subject matter described in this specification may be implemented as one or more computer program products, for example, one or more modules of computer program instructions encoded on a computer-readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer-readable medium may be a machine-readable storage device, a machine-readable storage substrate, a memory device, or a combination of one or more of them. The term “data processing apparatus” encompasses all apparatuses, devices, and machines for processing data, including but not limited to, by way of example, a programmable processor, a computer, or multiple processors or computers. The apparatus may include, in addition to hardware, code that creates an execution environment for the computer program in question (e.g., code that constitutes processor firmware, a protocol stack, a database management system, an operating system, or a combination thereof).

In some embodiments, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the present teachings are considered to include any one or more of a computer-readable medium or a distribution medium and other equivalents and successor media, in which data or instructions may be stored.

In some embodiments, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In some embodiments, the methods described herein may be implemented by software programs executable by a computer system. Further, in some embodiments, implementations may include distributed processing, component/object distributed processing, and parallel processing. Alternatively, virtual computer system processing may be constructed to implement one or more of the methods or functionality as described herein.

Although the present teachings describe components and functions that may be implemented in particular embodiments with reference to particular standards and protocols, the present invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform functions by operating on input data and generating output. The processes and logic flows may also be performed by, and apparatus may also be implemented as, special purpose logic circuitry, for example, an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The main elements of a computer are a processor for performing instructions and one or more memory devices for storing instructions and data. Generally, a computer will also include, or be operatively coupled to receive data from or transfer data to, or both, one or more mass storage devices for storing data, for example, magnetic, magneto optical disks, or optical disks. However, a computer need not have such devices. Moreover, a computer may be embedded in another device, for example, a mobile telephone, a personal digital assistant (PDA), a mobile audio player, a Global Positioning System (GPS) receiver, to name just a few. Computer-readable media suitable for storing computer program instructions and data include all forms of non volatile memory, media and memory devices, including but not limited to, by way of example, semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, some embodiments of subject matter described herein may be implemented on a device having a display, for example a CRT (cathode ray tube) or LCD (liquid crystal display) monitor, for displaying information to the user and a keyboard and a pointing device, for example a mouse or a trackball, by which the user may provide input to the computer. Other kinds of devices may be used to provide for interaction with a user as well. By way of example, feedback provided to the user may be any form of sensory feedback (e.g., visual feedback, auditory feedback, or tactile feedback); and input from the user may be received in any form, including but not limited to acoustic, speech, or tactile input.

Embodiments of subject matter described herein may be implemented in a computing system that includes a back-end component, for example, as a data server, or that includes a middleware component, for example, an application server, or that includes a front end component, for example, a client computer having a graphical user interface or a Web browser through which a user may interact with an implementation of the subject matter described in this specification, or any combination of one or more such back end, middleware, or front end components. The components of the system may be interconnected by any form or medium of digital data communication, for example, a communication network. Examples of communication networks include but are not limited to a local area network (LAN) and a wide area network (WAN), for example, the Internet.

The computing system may include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 CFR §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding claim—whether independent or dependent—and that such new combinations are to be understood as forming a part of the present specification.

The foregoing detailed description and the accompanying drawings have been provided by way of explanation and illustration, and are not intended to limit the scope of the appended claims. Many variations in the presently preferred embodiments illustrated herein will be apparent to one of ordinary skill in the art, and remain within the scope of the appended claims and their equivalents.

1. A computer-implemented method for processing medical imaging data, the method comprising:
selecting, by a first computer processor, a subset of medical imaging data to be processed, wherein the medical imaging data is stored in a cloud-based storage system;
choosing, by the first computer processor, a processing algorithm to apply to the selected subset of medical imaging data, wherein the chosen processing algorithm is stored in the cloud-based storage system;
executing, by a second computer processor, the chosen processing algorithm in the cloud-based storage system to generate a processing result; and
displaying the processing result to a client via a user interface.

2. The computer-implemented method of claim 1 wherein the cloud-based storage system comprises a network.

3. The computer-implemented method of claim 2 further comprising partitioning the network into a plurality of network segments.

4. The computer-implemented method of claim 3, wherein the partitioning is configured for optimizing the processing result.

5. The computer-implemented method of claim 2 wherein the network comprises a plurality of network segments, and wherein each network segment of the plurality of network segments comprises one or a plurality of modules of the processing algorithm.

6. The computer-implemented method of claim 5 wherein two or more of the plurality of network segments are configured to run in parallel in the cloud-based storage system.

7. The computer-implemented method of claim 5 wherein two or more of the plurality of network segments are configured for transferring data therebetween.

8. The computer-implemented method of claim 5 wherein each network segment of the plurality of network segments is independently configured to run on a separate computer.

9. The computer-implemented method of claim 5 wherein each network segment of the plurality of network segments is controlled by a common driver.

10. The computer-implemented method of claim 1 wherein the executing comprises parallel processing of at least two modules of the chosen processing algorithm.

11. The computer-implemented method of claim 1 wherein the subset of medical imaging data comprises data corresponding to a specific patient.

12. The computer-implemented method of claim 1 wherein the cloud-based storage system comprises a plurality of processing algorithms, and wherein each processing algorithm of the plurality of processing algorithms is configured to run in the cloud-based storage system.

13. The computer-implemented method of claim 1 further comprising transmitting medical imaging data to the cloud-based storage system over a network.

14. The computer-implemented method of claim 1 wherein the user interface comprises a web-based browser.

15. The computer-implemented method of claim 1 wherein the medical imaging data comprises computed tomography (CT) data, magnetic resonance imaging (MRI) data, ultrasound data, fluoroscopy data, x-ray data, positron emission data, or a combination thereof.

16. The computer-implemented method of claim 1 wherein the processing of the subset of medical imaging data comprises analyzing, detecting, segmenting, rendering, modeling, annotating, comparing, reporting, or a combination thereof.

17. The computer-implemented method of claim 1 wherein the processing algorithm is configured to generate patient-specific information for surgery planning, orthopedic implant design, surgical instrument design, surgical instrument placement, or a combination thereof.

18. The computer-implemented method of claim 17 wherein the subset of medical imaging data comprises computed tomography (CT) data, magnetic resonance imaging (MRI) data, or a combination thereof.

19. A system for processing medical imaging data, the system comprising:
a first computer processor;
a first non-transitory memory coupled with the first computer processor;
first logic stored in the first non-transitory memory and executable by the first computer processor to cause the first computer processor to select a subset of medical imaging data to be processed, wherein the medical imaging data is stored in a cloud-based storage system;
second logic stored in the first non-transitory memory and executable by the first computer processor to cause the first computer processor to choose a processing algorithm to be applied to the selected subset of medical imaging data, wherein the chosen processing algorithm is stored in the cloud-based storage system;
a second computer processor in communication with the first computer processor over a network;
a second non-transitory memory coupled with the second computer processor;
third logic stored in the second non-transitory memory and executable by the second computer processor to cause the second computer processor to execute the chosen processing algorithm in the cloud-based storage system to generate a processing result; and
fourth logic stored in the second non-transitory memory and executable by the second computer processor to cause the second computer processor to display the processing result to a client via a user interface.

20. The system of claim 19 further comprising:
fifth logic stored in the second non-transitory memory and executable by the second computer processor to cause the second computer processor to receive the selection of the subset of medical imaging data to be processed; and
sixth logic stored in the second non-transitory memory and executable by the second computer processor to cause the second computer processor to receive the choice of processing algorithm to be applied to the selected subset of medical imaging data.

21. A non-transitory computer-readable storage medium having stored therein data representing instructions executable by a programmed processor for processing medical imaging data, the storage medium comprising instructions for:
selecting a subset of medical imaging data to be processed, wherein the medical imaging data is stored in a cloud-based storage system;
choosing a processing algorithm to apply to the selected subset of medical imaging data, wherein the chosen processing algorithm is stored in the cloud-based storage system;
executing the chosen processing algorithm in the cloud-based storage system to generate a processing result; and
displaying the processing result to a client via a user interface.
